(19) United States
(12) Patent Application Publication
(10) Pub. No.: US 2006/0103797 A1
(43) Pub. Date: May 18, 2006

(54) Normally-white TN-mode LCD device

(75) Inventors: Yoichi Sasaki, Nakahara-ku (JP); Hidenori Ikeno, Nakahara-ku (JP)

Correspondence Address: Norman P. Soloway;HAYES SOLOWAY P.C., Suite 140, 3450 E. Sunrise Drive, Tucson, AZ, 85718, US

(73) Assignee: NEC LCD Technologies, Ltd.

(21) Appl. No.: 11/268,810

(22) Filed: Nov. 7, 2005

(30) Foreign Application Priority Data
Nov. 16, 2004 (JP) 2004-331410

(51) Int. Cl. G02F 1/1335

(52) U.S. Cl. 349/119

(57) ABSTRACT

A normally-white twisted-nematic-mode LCD device has first and second optical compensation films for compensating the retardation of an LC layer sandwiched between a pair of substrates. The LC layer is applied with an applied voltage Vw having a relation with respect to the threshold voltage Vth of the LC and a pre-tilt angle θ of the LC layer, as follows:
Vw≦Vth×exp(−0.235×θ+7.36×10⁻³). By using the applied voltage Vw depending on the pre-tilt angle θ increases the viewing angle which achieves a desired contrast ratio.

### BACKGROUND OF THE INVENTION

(a) Field of the Invention

The present invention relates to a liquid crystal display (LCD) device and, more particularly, to a normally-white twisted-nematic-mode (TN-mode) LCD device including liquid crystal (LC) molecules having a twisted angle of around 90 degrees.

(b) Description of the Related Art

In general, TN-mode LC devices consecutively include first polarization film, first glass substrate, LC layer, second glass substrate, and second polarization film, arranged in this order as viewed from the light incident side thereof. The LC layer includes LC molecules having a longer axis oriented parallel to the substrate surface upon applying no electric field thereto. The LC molecules are twisted by 90 degrees in the longer axis thereof from the first substrate to the second substrate. In the normally-white TN-mode LCD device, the first and second polarization films are arranged so that the polarization axes thereof are disposed perpendicular to each other and thus the LCD device exhibits white color upon application of no electric field.

A viewing angle characteristic, showing a range of the viewing angle in which the LCD device achieves a specific contrast ratio or above, is known as one of the important indexes of the performances of the LCD device. The specific contrast ratio employed is 10:1, for example, as a luminance ratio of white color to black color measured in a printed sheet wherein a high-quality sheet of white paper is printed with a black ink.

In general, the horizontal direction of the LCD device is determined to be perpendicular to the longer axis of the LC molecules residing at the middle of the LC layer between the substrates upon display of white color. In addition, from both opposite directions along the vertical longer axis of the LC molecules at the middle of the LC layer, a counter-viewing-angle direction in which tone reversal is likely to occur from the narrower viewing angle is selected as the downward direction and the positive-viewing-angle direction opposite to the counter-viewing-angle direction is selected as the upward direction. In a catalogue of the LCD devices, for example, the viewing angle characteristic of the vertical direction and the horizontal direction is listed for each LCD device.

It is known in the LCD device that the refractive index anisotropy of the LC layer reduces the contrast ratio in a slanted viewing direction to degrade the viewing angle characteristic of the LCD device. Patent publications No. JP-A-9(1997)-15586 and -2004-133487 describe a solution for the problem of the refractive index anisotropy. The technique shown therein is such that an optical compensation film, or retardation film, having an optical polarity opposite to the optical polarity of the LC layer is disposed between the first polarization film and the first glass substrate as well as between the second polarization film and the second glass substrate to compensate the change in the polarized state of the LC layer.

### DISCLOSURE OF THE INVENTION

### (a) PROBLEM TO BE SOLVED BY THE INVENTION

In the typical normally-white TN-mode LCD device, the LCD driver driving the LC layer of the LCD device applies a minor voltage between the electrodes even upon display of white color. This minor voltage may change the orientation of the LC molecules upon the display of white color to reduce the transmission of light through the LC layer and thus reduce the white luminance at each viewing angle. Thus, the TN-mode LCD device suffers from degradation of the total contrast ratio, to thereby reduce the range of viewing angle achieving the contrast ratio of 10:1 or above.

In JP-A-2004-133487, the applied voltage upon display of white color is set to obtain a 90 to 97% transmission range, while using the transmission of light obtained between the first polarization film and the second polarization film upon display of no electric field as the standard transmission (100%). However, the setting of the applied voltage to this range upon the display of white color does not sufficiently improve the viewing angle characteristic, i.e., is unable to achieve a viewing angle of 80 degrees or above in each of the left and right sides of the horizontal direction.

The TN-mode LCD device includes an orientation film between the first glass substrate and the LC layer as well as between the LC layer and the second substrate. The LC molecules have a pre-tilt angle with respect to the substrate surface due to the presence of the orientation film. The relationship between the applied voltage and the transmission (transmission factor) of light upon the display of white color depends on the physical property of the LC and the pre-tilt angle. However, the range of applied voltage is not known in the art which achieves a sufficient viewing angle, i.e., as high as 80 degrees or above, in the horizontal direction upon the display of white color depending on the physical property of the LC and the pre-tilt angle.

In view of the above, it is an object of the present invention to provide an LCD device which is capable of achieving a superior viewing angle characteristic wherein a viewing angle of 80 degrees or above achieving a desired contrast ratio is obtained in the horizontal direction.

### (b) SUMMARY OF THE INVENTION

The present invention provides a normally-white liquid-crystal-display (LCD) device including a first polarization film, a first optical compensation film, a first substrate, a first orientation film, a twisted-nematic-mode liquid crystal (LC) layer having a twisted angle of around 90 degrees, a second orientation film, a second substrate, a second optical compensation film and a second polarization film, the first and second optical compensation films each having a negative optical characteristic which is opposite to an optical characteristic of the LC layer, the twisted angle (θ) of the LC layer and an applied voltage (Vw) applied to the LC layer upon display of white color satisfying, for a given threshold voltage Vth of the LC layer, the following relationship:
Vw≦=Vth×exp(−0.235×θ+7.36×10⁻³),
the given threshold voltage Vth being defined by the following formula:

$$Vth = π \sqrt{\frac{{K}_{11} + ( {K}_{33} - 2 {K}_{22} ) / 4}{{ɛ}_{0} Δ ɛ}}$$

where K₁₁, K₂₂ and K₃₃ are elastic coefficients of LC molecules in the LC layer for splay deformation, twisted deformation and bending deformation, respectively, and Δε and ε₀ are dielectric constant anisotropy and electric constant, respectively.

In accordance with the LCD device of the present invention, the applied voltage Vw applied to the LC layer upon display of white color is set to a value satisfying the above relationship depending on the pre-tilt angle, whereby a 99.9% or above transmission of the LC layer is obtained upon the display of white color and thus increases the range of viewing angle which achieves a desired contrast ratio.

It is preferable in the LCD device of the present invention that the viewing angle achieving a contrast ratio of 10:1 in a horizontal direction be 80 degrees or above.

In a preferred embodiment of the present invention, the first optical compensation film compensates a retardation of a first portion of the LC layer near the first substrate, and the second optical compensation film compensates a retardation of a second portion of the LC layer near the second substrate. In this case, the LCD device has an improved image quality especially as to the image observed in the slanted viewing direction.

In the preferred embodiment of the LCD device, it is assumed here that the first and second portions of the LC layer each have therein a plurality (n) of thin virtual LC films. The first and second optical compensation films each include a plurality (n) of discotic LC layers having a negative single-axis optical characteristic, arranged in the direction of light transmission and each compensating a corresponding one of the plurality of thin virtual LC films in a corresponding one of the first and second portions.

An i-th discotic layer (1≦=i≦n) of the first optical compensation film having an ordered number as counted from the first substrate has a longer axis substantially parallel to the longer axis of an i-th thin virtual LC film in the first portion having an ordered number as counted from the first substrate upon display of black color, whereby the i-th discotic layer of the first compensation film compensates a retardation of the i-th thin virtual LC film in the first portion.

An i-th discotic layer of the second optical compensation film having an ordered number as counted from the second substrate has a longer axis substantially parallel to the longer axis of an i-th thin virtual LC film in the second portion having an ordered number as counted from the second substrate upon display of black color, whereby the i-th discotic layer of the second optical compensation film compensates a retardation of the i-th thin virtual LC film in the first portion.

In the configuration of the preferred embodiment as described above, the first and second optical compensation films intensify the compensating function of each other to thereby further improve the image quality of the LCD device. Use of this configuration may possibly raise the viewing angle which achieves a contrast ratio of 10:1 up to 80 degrees or above in the horizontal direction.

It is also preferable that the first optical compensation film have a negative single-axis optical characteristic, and have a refractive index ellipsoid having an optical axis substantially parallel to the longer axis of the LC molecules in the vicinity of the first substrate upon display of black color, and that the second optical compensation film have a negative single-axis optical characteristic, and have a refractive index ellipsoid having an optical axis substantially parallel to the longer axis of the LC molecules in the vicinity of the second substrate upon display of black color. In this configuration, the first and second optical compensation films compensate the retardation of the LC layer to thereby improve the image quality of the LCD device.

In the LCD device of the present invention, setting the applied voltage depending on the pre-tile angle upon display of white color improves the white luminescence at each pre-tilt angle, thereby increasing the viewing angle which achieves a desired contrast ratio and thus improving the image quality of the LCD device.

The above and other objects, features and advantages of the present invention will be more apparent from the following description, referring to the accompanying drawings.

### BRIEF DESCRIPTION OF THE DRAWINGS

FIG. 1 is a schematic sectional view of an LCD device according to a first embodiment of the present invention.

FIG. 2 is a schematic sectional diagram of the LCD device of FIG. 1, showing the arrangement of the LC molecules and the optical characteristic of the first and second optical compensation films.

FIG. 3 is a graph showing the relationship obtained by simulation between the applied voltage and the transmission of the LC layer at a lo variety of pre-tilt angles.

FIGS. 4A and 4B show a contrast viewing cone upon display of white color in the case of transmission factor of 96% and 99.9%, respectively.

FIG. 5 is a detailed graph magnifying the vicinity of a transmission factor of 100% shown in FIG. 3.

FIG. 6 is a table showing the relationship obtained from FIG. 5 between the pre-tilt angle and the applied voltage achieving a transmission factor of 99.9%.

FIG. 7 is a table obtained by simulation to show the viewing angle characteristic of the LCD device at each pre-tilt angle.

FIG. 8 is a schematic sectional diagram showing the optical characteristics of the first and second compensation films in an LCD device according to a second embodiment of the present invention.

FIG. 9 is a table obtained by simulation to show the viewing angle characteristic of the LCD device at each pre-tilt angle.

### PREFERRED EMBODIMENT OF THE INVENTION

Now, the present invention is more specifically described with reference to accompanying drawings, wherein similar constituent elements are designated by similar reference numerals throughout the drawings.

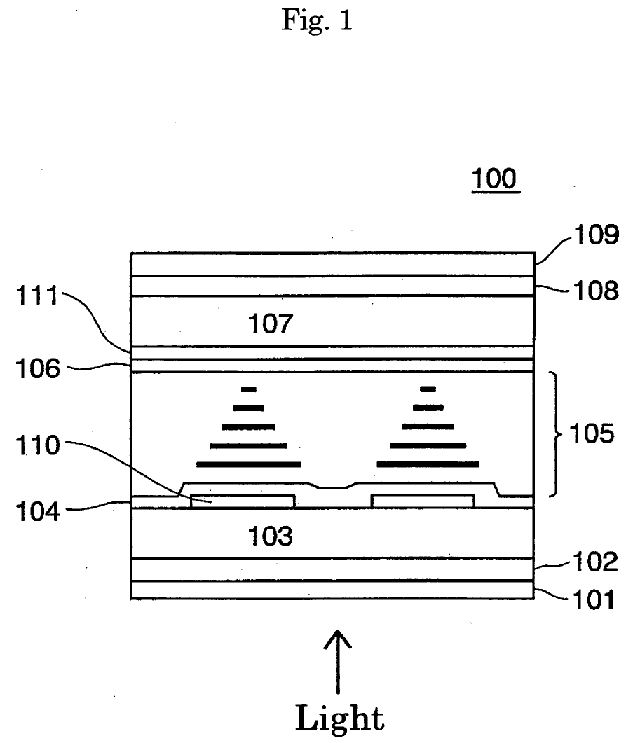

Referring to FIG. 1, an LCD device, generally designated by numeral 100, according to a first embodiment of the present invention includes a first polarization film 101, a first compensation film 102, a lo first glass substrate 102, a first orientation film 104, an LC layer 105, a second orientation film 106, a second glass substrate 107, a second optical compensation film 108 and a second polarization film 109, which are arranged in this order in the direction of the transmission of light. The LCD device 100 is of a normally-white TN mode.

The first and second polarization films 101, 109 each have a function of allowing the light having a specific polarized direction to pass therethrough. The polarization axis of the first polarization film 101 is perpendicular to that of the second polarization film 109. The first glass substrate 103 configures a TFT (thin-film-transistor) substrate, for example, whereas the second glass substrate 107 configures a color-filter substrate or counter substrate. The LC layer 105 includes therein TN-mode LC having a twisted angle of around 90 degrees. The first and second glass substrates 103, 107 each mount thereon a transparent electrode 110 or 111, which applies an electric field to the LC layer 105 to control the LC molecules therein.

The first orientation film 104 controls orientation of the LC molecules in the vicinity of the interface between the LC layer 105 and the first glass substrate 103. The second orientation film 106 controls the LC molecules in the vicinity of the interface between the LC layer 105 and the second glass substrate 107. The LC molecules in the LC layer 105 rise from the surface of the first glass substrate 103 to a specific pre-tilt angle due to the function of the first orientation film 104, and rise from the surface of the second glass substrate 107 to a specific pre-tilt angle due to the function of the second orientation film 106. The first and second optical compensation films 102, 108 each have a negative single-axis index anisotropy, and has an effective optical axis inclined to a specific angle with respect to the normal line of the substrate surface. The first and second optical compensation films 102, 108 may be made of a WV film (trade mark) supplied from Fuji film inc., for example.

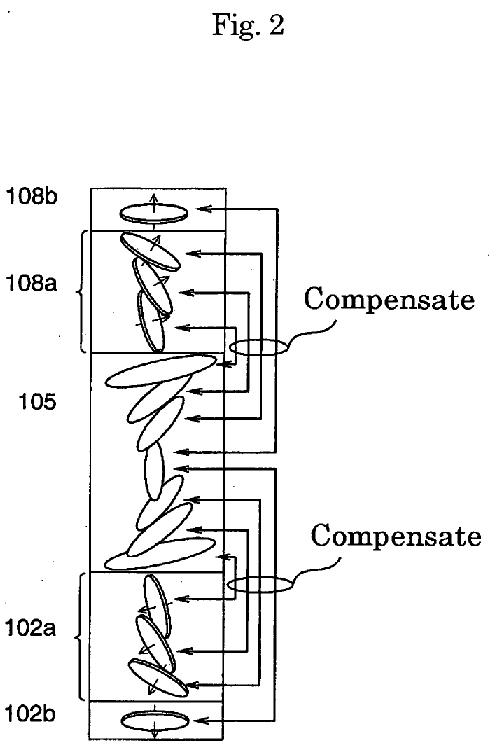

FIG. 2 schematically shows the orientation of the LC molecules in the LC layer 105 and the optical characteristic of the first and second optical compensation films 102, 108. In FIG. 2, the first and second glass substrates 103, 107 are omitted for depiction. In addition, the twisted angle of the LC molecules are neglected.

In the LC layer 105, most of the LC molecules rise, as shown in the figure, upon display of black color due to the electric field applied by the transparent electrode 110 formed on the first glass substrate (103 in FIG. 1) and the transparent electrode 111 formed on the second glass substrate (107 in FIG. 1). The LC molecules in the vicinity of the interface between the first glass substrate 103 and the LC layer 105 and the interface between the LC layer 105 and the second glass substrate 107 do not completely rise, due to the fixing function of the first and second orientation films 104 and 106.

Assuming that the LC layer 105 is divided into three portions including a front portion, a central portion, and a rear portion, the first compensation film 102 compensates a residual retardation of the LC in the rear portion thereof near the first compensation film 102. The first optical compensation film 102 includes a discotic LC section 102a, wherein a plurality of discotic LC layers having different directions of optical axis are stacked one on another, and a TAC (triacetyl-cellulose) film 102b.

In the exemplified case shown in FIG. 2, the discotic LC section 102a includes three discotic LC layers, and one of the discotic LC layers nearest to the LC layer 105 has an optical axis substantially parallel to the longer axis of the LC molecules in one of the thin virtual LC films nearest to the first optical compensation film 102 upon display of black color to thereby compensate the residual retardation thereof.

The central discotic LC layer of the first optical compensation film 102 is disposed so that the optical axis thereof is substantially parallel to the longer axis of the LC molecules in the central thin virtual LC film in the rear portion of the LC layer 105 upon display of black color, to thereby compensate the residual retardation of the central thin virtual LC film. The discotic LC layer nearest to the TAC film 102b is disposed so that the optical axis thereof is substantially parallel to the longer axis of the LC molecules in the front thin virtual LC film of the rear portion of the LC layer 105, to thereby compensate the residual retardation thereof.

The TAC film 102b has a negative single-axis optical characteristic and has an optical axis normal to the substrate surface, thereby compensating the residual retardation of the LC molecules in the central portion of the LC layer 105.

The second optical compensation film 108 compensates the residual retardation of the front portion of the LC layer 105 near the second optical compensation film 104 upon display of black color. The second optical compensation film 108 includes a discotic LC section 108a, wherein a plurality of discotic LC layers having different directions of the optical axis are stacked one on another, and a TAC film 108b.

As exemplarily illustrated in FIG. 2, the discotic LC section 108a includes three discotic LC layers, and one of the discotic LC layers nearest to the LC layer 105 has an optical axis substantially parallel to the longer axis of the LC molecules in one of the thin virtual LC films nearest to the second optical compensation film 108 upon display of black color, to thereby compensate the residual retardation thereof.

The central discotic LC layer of the second optical compensation film 108 is disposed so that the optical axis thereof is substantially parallel to the longer axis of the LC molecules in the central thin virtual LC film in the front portion of the LC layer 105 upon display of black color, to thereby compensate the residual retardation of the central virtual LC film. The discotic LC layer nearest to the TAC film 102b is disposed so that the optical axis thereof is substantially parallel to the longer axis of the LC molecules in the front thin virtual LC film of the front portion of the LC layer 105, to thereby compensate the residual retardation thereof.

The TAC film 108b has a negative single-axis optical characteristic and has an optical axis normal to the substrate surface, thereby compensating the residual retardation of the LC molecules in the central portion of the LC layer 105.

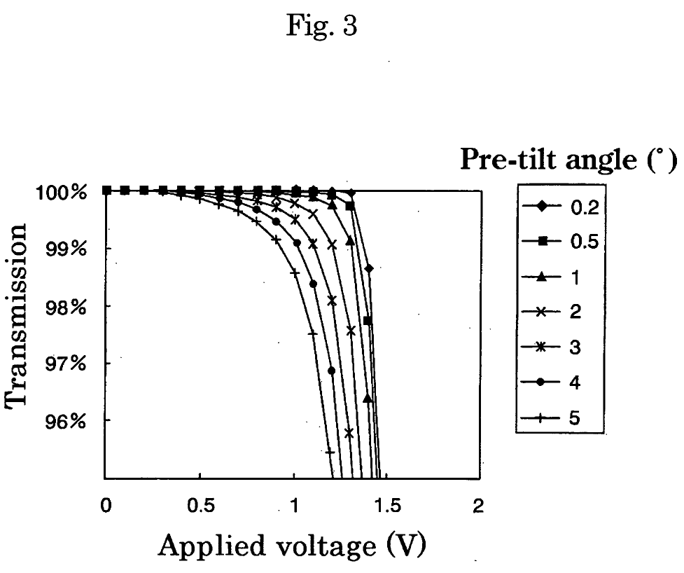

FIG. 3 shows the relationship obtained by simulation between the applied voltage and the transmission of the LC layer 105. The simulation was conducted in order to find the range of applied voltage upon display of white color depending on the physical property of the LC and the pre-tilt angle for improving the viewing angle characteristic. In this simulation, the applied voltage was changed for the pre-tilt angles of 0.5 to 5.0 degrees, to measure the percent transmission at each applied voltage while assuming that the LC layer has a transmission of 100% upon application of zero volt. As understood from FIG. 3, a higher pre-tilt angle allows the measured transmission to reduce at a lower voltage from the 100% transmission.

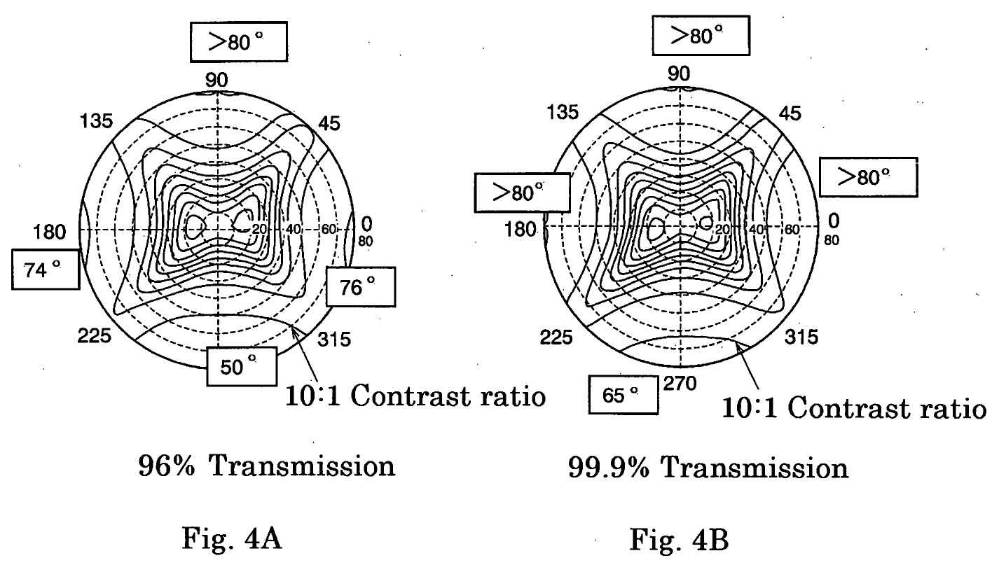

FIGS. 4A and 4B show a contrast viewing cone in the case of 96% and 99.9% transmission, respectively, of the LC layer upon display of white color and achieving a variety of contrast ratios. In these figures, the contrast ratio is represented in contour lines for an azimuth angle of 0 to 360 degrees and a polar angle of 0 to 80 degrees. The contour line for the contrast ratio of 10:1 is shown in the vicinity of the outer circle, and other contour lines for the contrast ratio of higher than 10:1 are shown in the central area. This shows the general principle that a lower viewing angle involves a higher contrast ratio.

In the conventional LCD device, display of white color involves an applied voltage to achieve a 96% transmission of the LC layer upon display of white color, as shown in FIG. 4A, wherein the viewing angle achieving the contrast ratio of 10:1 is around 75 degrees in the lo horizontal direction, i.e., at an azimuth angle of 0 degrees and 180 degrees. In contrast, as shown in FIG. 4B, if the transmission of the LC layer upon display of white color is set to 99.9%, the viewing angle in the horizontal direction is increased up to above 80 degrees for the azimuth angle of 0 degrees and 180 degrees.

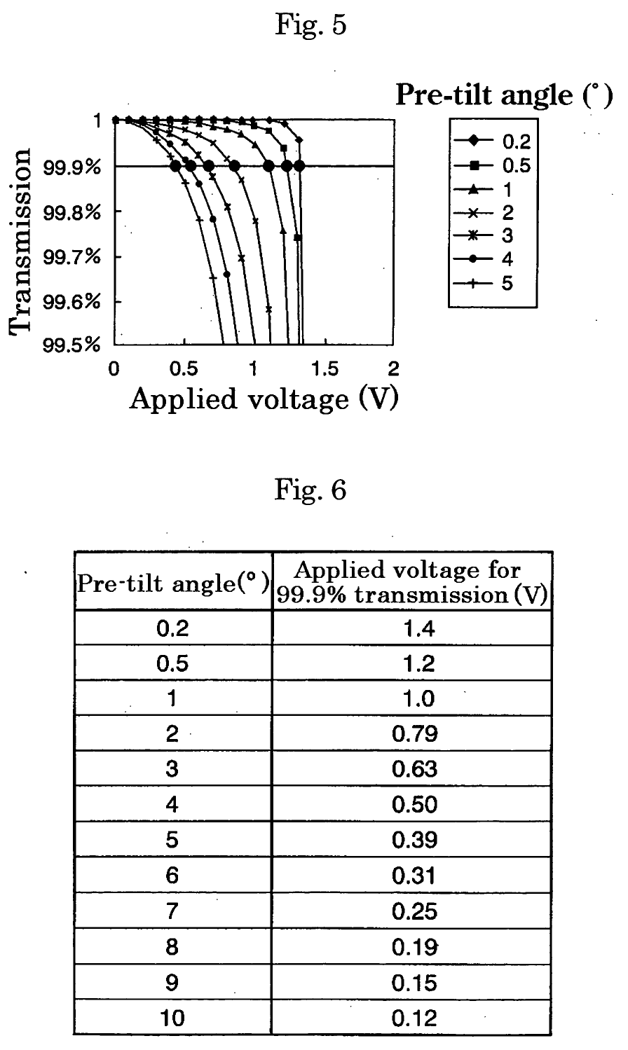

FIG. 5 shows the detail of the vicinity of the 100% transmission in the graph of FIG. 3. In FIG. 5, the intersection of the transmission curve and the transmission of 99.9% at a pre-tilt angle between 0 degrees and 10 degrees represents the applied voltage to achieve the transmission of 99.9%. The applied voltage represented by the intersection in FIG. 5 is tabulated in FIG. 6 for each of the pre-tilt angles between 0 degrees and 10 degrees. In general, the LC layer having a specific twisted angle has a corresponding threshold voltage Vth, which represents Freedericksz transition point of the LC.

Use of the relationship between the pre-tilt angle and the applied voltage in FIG. 5 reveals the applied voltage Vw which achieves the transmission of 99.9% upon display of white color for each of the pre-tilt angles, according to the principle of the present invention. The applied voltage Vw satisfies the relationship by using the threshold voltage Vth of the LC layer 105 having a twisted angle of around 90 degrees and the pre-tilt angle θ (degree), as follows:
Vw≦Vth×exp(−0.235×θ+7.36×10⁻³) (1)
where 0≦θ≦10.

The threshold voltage Vth as used above represents Freedericksz transition point of the LC at a twisted angle of 90 degrees, and can be expressed by using dielectric constant anisotropy Δε and elastic coefficients K₁₁, K₂₂ and K₂₃ as follows:

$$Vth = π \sqrt{\frac{{K}_{11} + ( {K}_{33} - 2 {K}_{22} ) / 4}{{ɛ}_{0} Δ ɛ}} , \qquad ( 2 )$$

where K₁₁, K₂₂ and K₃₃ are elastic coefficients of splay deformation, twisted deformation and bending deformation, respectively. This formula is described in a literature entitled “Techniques for measuring properties of LC material (2), in the 4th course of LC science experimental courses ” presented by Okamura and Ichinose.

The dielectric constant anisotropy Δε is calculated after measuring the relative permittivity of the LC in the directions parallel and normal to the longer axis of the LC molecules in a perpendicularly oriented LC cell and a horizontally oriented LC cell by using an LCR meter, as described in the same literature. The elastic coefficients K₁₁, K₂₂ and K₃₃ are obtained by measuring the change in the intensity of the light passed by the LC cells caused by the change in the intensity of the external magnetic field or electric field, and by conducting a curve fitting with respect to a theoretical equation. The pre-tilt angle θ can be measured by using LCA-LAU (trade mark) from Nabishi Technica.

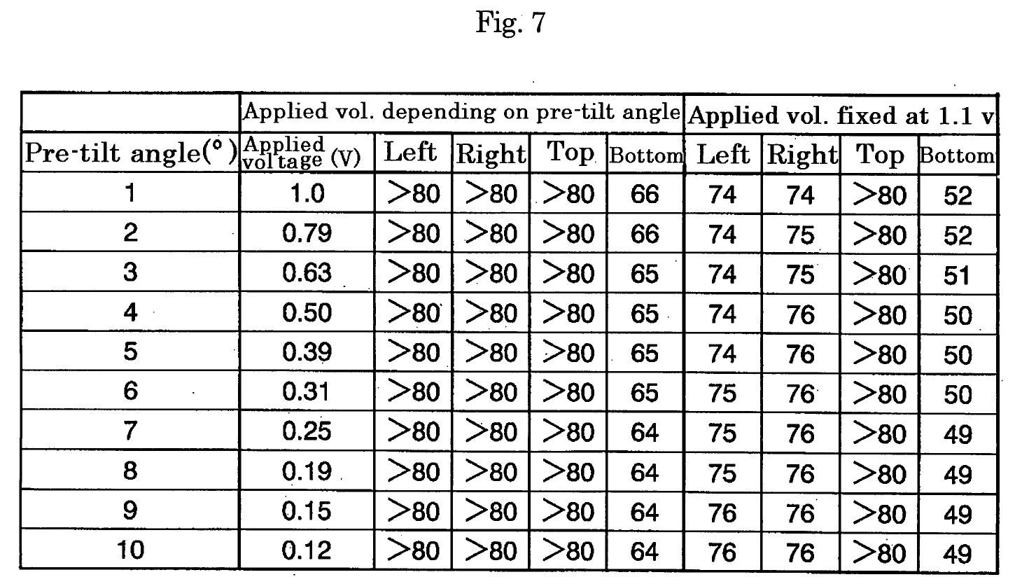

FIG. 7 shows the viewing angle characteristic at each pre-tilt angle of the LCD device, obtained by simulation. The simulation used the assumption that the LC layer has properties of K₁₁=9.1 pN, K₂₂=8.6 pN, K₃₃=18.8 pN, Δε=6.1 volts, and the retardation Δnd=390 nm. The simulation also assumed first and second optical compensation films 102, 108 each including a discotic LC section having a vertical retardation Rth of 120 nm at a wavelength of 550 nm, and a TAC film having a retardation Rth of 150 nm and an optical axis 18 degrees inclined from the normal line of the substrate.

The simulation was conducted in both cases of the applied voltage Vw being set at the upper limit of the relationship (1) according to the present invention and set at 1.1 volts irrespective of the pre-tilt angle in a comparative example. The simulation revealed the viewing angle characteristic in the horizontal and vertical directions, the results of which are shown in the table of FIG. 7 described above. In FIG. 7, the numbers in the columns denoted by “left”, “right”, “top” and “bottom” at the top of the column represent the viewing angle achieving the contrast ratio of 10:1 at respective pre-tilt angles.

As understood from FIG. 7, the LCD device using an applied voltage of 1.1 volts upon display of white color did not have a viewing angle of 80 degrees or above which achieves a contrast ratio of 10:1 or above, revealing a lower viewing angle characteristic. In contrast, the LCD device using an applied voltage defined by the upper limit in the relationship (1) had a viewing angle of higher than 80 degrees in both the horizontal and vertical directions except for the bottom at each pre-tilt angle, thereby revealing a higher viewing angle characteristic. The lower viewing angle (around 65 degrees in FIG. 7) for the bottom, i.e., at an azimuth angle 270 degrees in FIGS. 4A and 4B, is a minor defect because the LCD device is scarcely observed from the bottom in general.

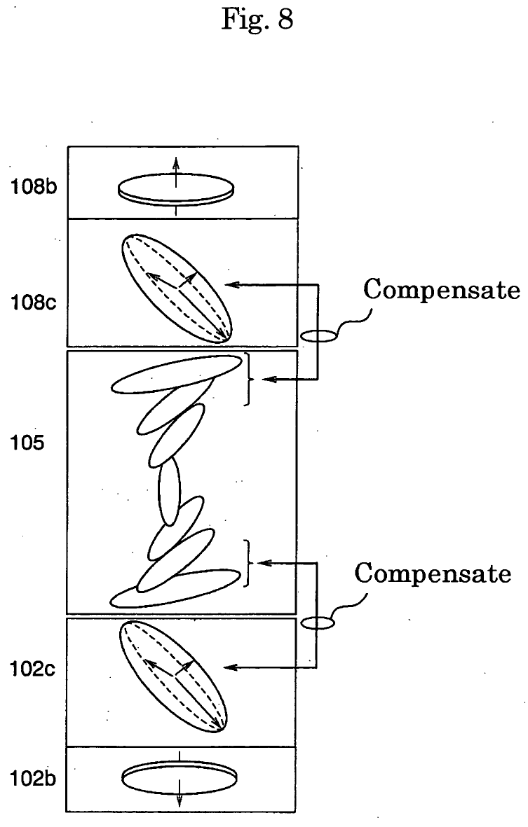

FIG. 8 schematically shows the optical characteristic of the first and second optical compensation films used in an LCD device according to a second embodiment of the present invention. The LCD device according to the second embodiment is similar to the LCD device of the first embodiment except for the configuration of the first and second optical compensation films, which will be detailed hereinafter.

The first optical compensation film 102 includes a compensation film 102c having a negative single-axis optical characteristic having a specific inclined angle with respect to the substrate surface instead of the discotic LC section 102a used in the first embodiment. The compensation film 102c is disposed so that the specific inclined angle of the optical axis thereof coincides with the average inclined angle of the optical axes of the LC molecules in the vicinity of the interface between the LC layer 105 and the first glass substrate 103 (in FIG. 1) upon display of black color. Thus, the compensation film 102c compensates the residual retardation of the LC molecules in the vicinity of this interface.

The second optical compensation film 108 includes a compensation film 108c having a negative single-axis optical characteristic having a specific inclined angle with respect to the substrate surface instead of the discotic LC section 108a used in the first embodiment. The compensation film 108c is disposed so that the specific inclined angle of the optical axis thereof coincides with the average inclined angle of the optical axes of the LC molecules in the vicinity of the interface between the LC layer 105 and the second glass substrate 107 upon display of black color. Thus, the compensation film 102c compensates the residual retardation of the LC molecules in the vicinity of this interface.

The relationship between the transmission of the LC layer 105 and the applied voltage depends on the properties of the LC material. Thus, the relationship between the transmission of the LC layer 105 and the applied voltage upon display of white color at each pre-tilt angle in the present embodiment is similar to that in the first embodiment, which is shown in FIG. 3. Accordingly, the applied voltage is set to satisfy the relationship (1) upon display of white color depending on the pre-tilt angle, thereby achieving the transmission of 99.9% upon display of white color and improving the viewing angle characteristic.

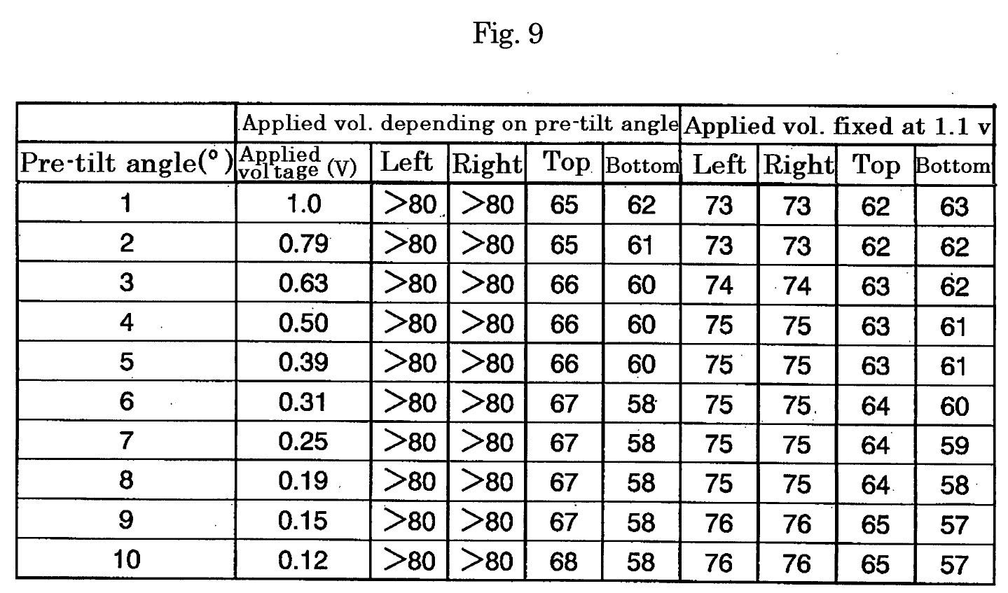

FIG. 9 shows the viewing angle characteristic of the LCD device of the present embodiment obtained by simulation at each pre-tilt angle. The simulation used the assumption that the LC layer 105 has properties of K₁₁=9.1 pN, K₂₂=8.6 pN, K₃₃=18.8 pN, Δε=6.1 volts and retardation Δnd=390 nm, which are similar to those in the first embodiment. The simulation also assumed first and second optical compensation films each including a compensation film having properties of Rth=120 nm and β=35 degrees, and a TAC film having a retardation Rth of 150 nm and an optical axis 18 degrees inclined with respect to the normal line of the substrate surface. The simulation was conducted in both cases of the applied voltage Vw being set at the upper limit of the relationship (1) according to the present invention and set at 1.1 volts irrespective of the pre-tilt angle in a comparative example. The results of the simulation are shown in FIG. 9.

The LCD device of the comparative example having the applied voltage of 1.1 volts did not have a viewing angle of 80 degrees or above, as shown in FIG. 9, in both the horizontal and vertical directions. In contrast, the LCD device of the present embodiment having the applied voltage set at the upper limit in the relationship (1) had a viewing angle of 80 degrees or above in the horizontal direction achieving a contrast ratio of higher than 10:1, as shown in FIG. 9, although the viewing angle in the vertical direction is relatively low.

Comparing the results shown in FIG. 9 against the results shown in FIG. 7, the LCD device of the second embodiment having the applied voltage set at the upper limit in the relationship (1) exhibited a high viewing angle in the horizontal direction similar to that in the first embodiment, although it exhibited a somewhat lower viewing angle for the top in the vertical direction. Thus, it was confirmed that the first and second optical compensation films 102, 108 having a negative single-axis optical characteristic achieved a higher viewing angle of 80 degrees or above in the horizontal direction so long as the applied voltage satisfied the relationship (1) upon display of white color. Thus, the LCD device of the second embodiment also achieves a higher image quality.

The Rh value and β value of the first and second optical compensation films in the second embodiment are not restricted to the above exemplified values, and may be selected as desired depending on the properties of the LC. For example, an LCD device having properties of Rth=100 nm and β=35 degrees exhibited similar results in the simulation thereof.

Since the above embodiments are described only for examples, the present invention is not limited to the above embodiments and various modifications or alterations can be easily made therefrom by those skilled in the art without departing from the scope of the present invention.

What is claimed is:

1. A normally-white liquid-crystal-display (LCD) device comprising a first polarization film, a first optical compensation film, a first substrate, a first orientation film, a twisted-nematic-mode liquid crystal (LC) layer having a twisted angle of around 90 degrees, a second orientation film, a second substrate, a second optical compensation film and a second polarization film, which are arranged in this order in a direction of light transmission,
said first and second optical compensation films each having a negative optical characteristic which is opposite to an optical characteristic of said LC layer, said twisted angle (θ) of said LC layer and an applied voltage (Vw) applied to said LC layer upon display of white color satisfying, for a given threshold voltage Vth of said LC layer, the following relationship:
Vw≦Vth×exp(−0.235×θ+7.36×10⁻³),
said given threshold voltage Vth being defined by the following formula:
$$Vth = π \sqrt{\frac{{K}_{11} + ( {K}_{33} - 2 {K}_{22} ) / 4}{{ɛ}_{0} Δ ɛ}} ,$$
where K₁₁, K₂₂ and K₃₃ are elastic coefficients of LC molecules in said LC layer for splay deformation, twisted deformation and bending deformation, respectively, and Δε and ε₀ are dielectric constant anisotropy and electric constant, respectively.

2. The LCD device according to claim 1, wherein a viewing angle achieving a contrast ratio of 10:1 in a horizontal direction is 80 degrees or above.

3. The LCD device according to claim 1, wherein said first optical compensation film compensates a retardation of a first portion of said LC layer near said first substrate, and said second optical compensation film compensates a retardation of a second portion of said LC layer near said second substrate.

4. The LCD device according to claim 1, wherein:
said first and second optical compensation films each include a plurality (n) of discotic LC layers having a negative single-axis optical characteristic, arranged in said direction of light transmission and each compensating a corresponding one of a plurality of (n) thin virtual LC films in a corresponding one of said first and second portions,
an i-th discotic layer (1≦i≦n) of said first optical compensation film having an ordered number as counted from said first substrate has a longer axis substantially parallel to a longer axis of an i-th thin virtual LC film in said first portion having an ordered number as counted from said first substrate upon display of black color, whereby said i-th discotic layer of said first compensation film compensates a retardation of said i-th thin virtual LC film in said first portion, and
an i-th discotic layer of said second optical compensation film having an ordered number as counted from said second substrate has a longer axis substantially parallel to a longer axis of an i-th thin virtual LC film in said second portion having an ordered number as counted from said second substrate upon display of black color, whereby said i-th discotic layer of said second optical compensation film compensates a retardation of said i-th thin virtual LC film in said first portion.

5. The LCD device according to claim 4, wherein a viewing angle achieving a contrast ratio of 10:1 in each of horizontal and vertical directions is 80 degrees or above.

6. The LCD device according to claim 3, wherein said first optical compensation film has a negative single-axis optical characteristic and refractive-index ellipsoid having an optical axis substantially parallel to a longer axis of LC molecules in a portion of said LC layer in a vicinity of said first substrate, and wherein said second optical compensation film has a negative single-axis optical characteristic and a refractive-index ellipsoid having an optical axis substantially parallel to a longer axis of LC molecules in a portion of said LC layer in a vicinity of said second substrate.
